(19) United States
(12) Patent Application Publication
(10) Pub. No.: US 2020/0018485 A1
(43) Pub. Date: Jan. 16, 2020

(54) HOME APPLIANCE DEVICE

(71) Applicant: BSH Hausgeräte GmbH, Munich (DE)

(72) Inventors: Cristina Diez Esteban, Zaragoza (ES); Pablo Jesus Hernandez Blasco, Zaragoza (ES); Georgios Kogias, Greece (GR); Sergio Llorente Gil, Zaragoza (ES); Ignacio Lope Moratilla, Zaragoza (ES); Maria Elena Moya Albertin, Zaragoza (ES); Charalampos Stergiou, Thessaloniki (GR); Vasiliki Tsakaloudi, THESSALONIKI (GR); Vassilios Zaspalis, Thessaloniki (GR)

(21) Appl. No.: 16/490,614

(22) PCT Filed: Mar. 12, 2018
(86) PCT No.: PCT/IB2018/051617

§ 371 Date: Sep. 3, 2019

(30) Foreign Application Priority Data
Mar. 30, 2017 (ES) P201730496

(51) Int. Cl. F24C 7/08; H05B 6/12

(52) U.S. Cl. CPC F24C 7/08; H05B 2206/022; H05B 6/1254

(57) ABSTRACT

A home appliance device, in particular a hob device, includes a ferrite element which is provided for concentrating a magnetic flux supplied by a coil and which contains a proportion of MnO and a proportion of NiO.

The invention relates to a household appliance device according to the preamble of claim 1 and to a method for producing a ferrite element for a household appliance device according to claim 10.

A household appliance device with at least one ferrite element is already known from the prior art, which is provided for concentrating a magnetic flux supplied by a coil. The ferrite element consists of a proportion of MnO, a proportion of ZnO and a proportion of Fe₂O₃ and is referred to as an MnZn ferrite element. Further materials are not contained in the ferrite element.

The object of the invention consists in particular in supplying a generic device with improved properties with respect to efficiency. This object is achieved according to the invention by the features of claims 1 and 10, while advantageous embodiments and developments of the invention can be taken from the subclaims.

The invention is based on a household appliance device, in particular on a cooking appliance device and advantageously on a hob device, having at least one ferrite element, which is provided for concentrating a magnetic flux supplied by a coil and which has at least one proportion of MnO.

It is proposed that the ferrite element has at least one proportion of NiO, as a result of which an efficiency, in particular a heating efficiency, can be improved. In particular, a high performance, in particular of the ferrite element and advantageously additionally also of a household appliance having the household appliance device, can be achieved, namely advantageously during a cooking process. In particular, a cooking process can be maintained for a long time by avoiding any adjustments which may be necessary in particular for protecting cooking appliance components and/or for ensuring a safe working range of cooking appliance components. With high temperatures, minimal power losses can be achieved in particular, namely in particular more minimal power losses than with an MnZn ferrite element, which consists in particular of a proportion of MnO, a proportion of ZnO and a proportion of Fe₂O₃. In particular, an advantageously high Curie temperature of the ferrite element can be enabled by the proportion of NiO, which is in particular greater than a Curie temperature known from an MnZn ferrite element, which consists in particular of a proportion of MnO, a proportion of ZnO and a proportion of Fe₂O₃.

A “household appliance device”, in particular a “cooking appliance device”, advantageously a “hob device” and particularly advantageously an “induction hob device” should be understood to mean in particular at least one part, in particular a sub-assembly, of a household appliance, in particular of a cooking appliance, advantageously of a hob and particularly advantageously of an induction hob. For instance, a household appliance having the household appliance device could be a deep freezer and advantageously a refrigerator and/or freezer. A household appliance having the housing appliance device could, alternatively or in addition, for instance, be a dishwasher and/or a washing machine and/or a dryer. Advantageously a household appliance having the household appliance device is a cooking appliance. A household appliance embodied as a cooking appliance could be a baking oven and/or a microwave and/or a grill device and/or a steam cooking appliance. A household appliance embodied as a cooking appliance is advantageously a hob and preferably an induction hob.

A “ferrite element” should in particular be understood to mean an element which consists at least largely of ferrite. “Ferrite” should in particular be understood to mean ferromagnetic and/or ferrimagnetic ceramic materials. “At least largely” should be understood as being, in particular, a proportion of at least 70%, in particular at least 80%, advantageously at least 90% and preferably at least 95%. In particular, the ferrite element is provided to improve a coupling between the coil and at least one positioned item of cookware, which is arranged in an installation position in particular at least partially above the coil. The ferrite element is in particular provided to, in particular significantly strengthen a magnetic flux supplied by the coil and thus to strengthen and/or increase heat losses induced in particular in the item of cookware, in particular in a base of the item of cookware, namely in particular compared with an embodiment by avoiding a ferrite element. In particular, the ferrite element is provided at least partially to shield at least one location against a magnetic flux supplied by the coil. The ferrite element is in particular provided to minimize leakage fields supplied by the coil.

The household appliance device has in particular the coil. In particular, the coil has at least one induction heating line. A “coil” should in particular be understood to mean an inductive component with at least one, in particular specific inductance. In particular, the coil is embodied at least essentially in the form of a disk, in particular in the form of a circular disk, alternatively in the form of an oval or a rectangle. The coil in particular has at least five, in particular at least ten, advantageously at least fifteen and preferably at least twenty windings of the induction heating line. For instance, windings of at least one coil section could be arranged in a number of planes. Preferably, windings of at least one coil section are arranged in a plane.

The term that an object has at least one “proportion of” a further object should in particular be understood to mean that the object consists in a mass proportion and/or volume proportion of more than 0% of the further object. MnO is in particular manganese(II) oxide. The ferrite element has in particular a mass proportion and/or volume proportion of at least 5%, in particular of at least 10%, advantageously of at least 15% and preferably of at least 20% of MnO. In particular, the ferrite element has a mass proportion and/or volume proportion of at most 40%, in particular of at most 35%, advantageously of at most 30% and preferably of at most 25% of MnO. NiO is in particular nickel(II) oxide.

“Provided” is to be understood in particular to mean especially configured and/or equipped. That an object is provided for a particular function should be understood in particular as meaning that the object fulfills and/or carries out this particular function in at least one usage and/or operational state.

For instance, the coil could be embodied as a throttle. The household appliance device preferably has the coil which is embodied as an induction heating element. The coil embodied as the induction heating element is in particular provided to generate an electromagnetic alternating field in particular with a frequency of 20 kHz to 100 kHz, which is in particular provided to be converted into heat in a positioned, in particular metallic, preferably ferromagnetic base of an item of cookware by means of eddy current induction and/or remagnetization effects. As a result, an optimized heating of a positioned item of cookware can be enabled in particular.

In addition, it is proposed that the ferrite element has a mass proportion and/or volume proportion of at least 0.5%, in particular of at least 1%, advantageously of at least 1.5%, particularly advantageously of at least 2% and preferably of at least 2.5% of NiO, as a result of which in particular an improved performance can be achieved.

Furthermore, it is proposed that the ferrite element has a mass proportion and/or volume proportion of NiO of at most 10%, in particular of at most 8%, advantageously of at most 7%, particularly advantageously of at most 6% and preferably of at most 5%, as a result of which an excessively high proportion of NiO and/or a reversal of a positive effect effected by the proportion of NiO on the performance can be avoided.

It is also proposed that the ferrite element has at least one proportion of ZnO. The ferrite element has in particular a mass proportion and/or volume proportion of at least 2%, in particular of at least 3%, advantageously of at least 4% and preferably of at least 5% of ZnO. In particular, the ferrite element has a mass proportion and/or volume proportion of at most 20%, in particular of at most 15%, advantageously of at most 10% and preferably of at most 8% of ZnO. ZnO is in particular zinc oxide. As a result, a cost-effective embodiment can be achieved in particular.

Moreover, it is proposed that the ferrite element has at least one proportion of Fe₂O₃. The ferrite element has in particular a mass proportion and/or volume proportion of at least 50%, in particular of at least 55%, advantageously of at least 60% and preferably of at least 65% of Fe₂O₃. In particular, the ferrite element has a mass proportion and/or volume proportion of at most 90%, in particular of at most 85%, advantageously of at most 80% and preferably of at most 75% of Fe₂O₃. Fe₂O₃ is in particular iron (III) oxide. As a result, a cost-effective embodiment can be achieved in particular.

It is also proposed that the ferrite element has a Curie temperature of at least 250° C., in particular of at least 260° C., advantageously of at least 270° C., particularly advantageously of at least 280° C. and preferably of at least 290° C., as a result of which in particular a cooking process can be carried out and/or enabled with particularly high temperatures. In particular, a high functional capability can be ensured even at high temperatures.

It is further proposed that the ferrite element has an initial permeability of at least 3000, in particular of at least 3200, advantageously of at least 3400, particularly advantageously of at least 3600 and preferably at least 3800, namely in particular at a frequency of at least essentially 10 KHz and in particular with a magnetic flux of at least essentially 0.1 mT and in particular with a temperature in a range of 180° C. to 200° C. The initial permeability of the ferrite element is in particular a permeability before an in particular initial magnetization of the ferrite element. “At least essentially” should in this context be understood to mean in particular that a deviation from a predetermined value deviates in particular less than 25%, preferably less than 10% and particularly preferably less than 5% from the predetermined value. As a result, a magnetic flux supplied by the coil can be strengthened in particular especially strongly, as a result of which a lower magnetic flux has to be produced in order to produce the same heat in a base of a positioned item of cookware as with an embodiment with a ferrite element with a lower initial permeability.

In particular, the ferrite element has a saturation flux density of at least 150 mT, in particular of at least 200 mT, advantageously of at least 250 mT and preferably of at least 300 mT, namely in particular with a frequency of at least essentially 10 KHz, and in particular with a magnetic field strength of at least essentially 1200 A/m and in particular with a temperature of at least essentially 200° C.

The ferrite element is in particular provided to effect power losses of at most 150 mW/cm³, in particular of at most 12 mW/cm³, advantageously of at most 100 mW/cm³, particularly advantageously of at most 80 mW/cm³ and preferably of at most 65 W/cm³, namely in particular with a frequency of at least essentially 20 KHz, and in particular with a magnetic flux of at least essentially 200 mT and in particular with a temperature of at least essentially 200° C. In particular, the ferrite element is provided to effect maximum power losses with a temperature of at least essentially 190° C.

A particularly high performance can be achieved in particular by a method for producing a household appliance device with at least one ferrite element, which is provided for concentrating a magnetic flux supplied by a coil and which has at least one proportion of MnO, at least one proportion of ZnO and at least one proportion of NiO, wherein a ratio of Mn to Zn with a varying proportion of NiO is kept at least essentially and in particularly completely constant. In particular, with an increasing proportion of NiO, the proportions of MnO and ZnO are reduced to the same degree. In particular, with a change in a proportion of NiO, a quotient of the proportion of MnO and the proportion of ZnO is kept at least essentially and in particular completely constant.

The household appliance device should in this regard not be restricted to the application and embodiment described above. In particular, in order to fulfill a functionality described herein, the household appliance device can have a number deviating from a number of elements, components and units cited herein.

Further advantages result from the following description of the figures. Exemplary embodiments of the invention are shown in the drawing. The drawing, the description and the claims contain numerous features in combination. The person skilled in the art will expediently also consider the features individually and combine the same to form useful further combinations.

In the drawing:

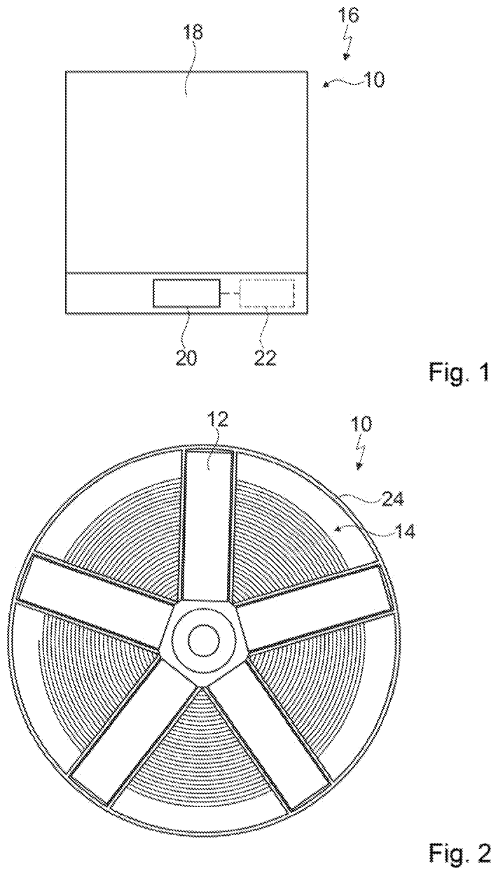

FIG. 1 shows a household appliance with a household appliance device in a schematic top view and

FIG. 2 shows a coil embodied as an induction heating element and five ferrite elements of the household appliance device in a schematic view from below onto the coil.

FIG. 1 shows a household appliance 16 with a household appliance device 10. The household appliance 16 could be embodied as a refrigerator and/or as a washing machine, for instance. In the present exemplary embodiment, the household appliance 16 is embodied as a cooking appliance, in particular as an induction cooking appliance. For instance, the household appliance 16 could be embodied as a baking oven, in particular as an induction baking oven, and/or as a cooker, in particular as an induction cooker, and/or as a cooking oven, in particular as an induction cooking oven. The household appliance 16 is embodied as a hob, in particular as an induction hob. The household appliance device 10 is embodied in the present exemplary embodiment as a cooking appliance device, in particular as an induction cooking appliance device. The household appliance device 10 is embodied as a hob device, in particular as an induction hob device.

The household appliance device 10 has a household appliance plate 18. In an assembled state, the household appliance plate 18 forms a part of an external appliance housing, in particular of the household appliance 16. The household appliance plate 18 forms, in an installation position, a part of the external appliance housing facing an operator. The household appliance plate 18 could be embodied for instance as a front plate and/or cover plate of the external appliance housing in particular of a household appliance 16 embodied as a baking oven and/or as a cooker and/or as a cooking oven and/or as a refrigerator and/or as a washing machine. In the present exemplary embodiment, the household appliance plate 18 is embodied as a hob plate. In an assembled state, the household appliance plate 18 is provided for positioning cookware.

The household appliance device 10 has a user interface 20 for inputting and/or selecting operating parameters (cf. FIG. 1), for instance a heat output and/or heat output density and/or a heating zone. The user interface 20 is provided to output a value of an operating parameter to an operator. For instance, the user interface 20 could optically and/or acoustically output the value of the operator parameter to an operator.

The household appliance device 10 has a control unit 22. The control unit 22 is provided to carry out actions and/or to change settings as a function of operating parameters input by means of the user interface 20.

In the present exemplary embodiment, the household appliance device 10 has a number of coils 14 (cf. FIG. 2). Only one of the coils 14 is shown. For instance, at least one part of the coils 14 could be arranged in the form of a matrix. Alternatively or in addition, at least one part of the coils 14 could in each case embody an independent heating zone. The coils 14 are embodied to be essentially identical, as a result of which only one coil 14 of the coils 14 is described below.

The coil 14 is embodied as an induction heating element. The coil 14 is provided to heat an item of cookware positioned above the coil 14 in an installation position on the household appliance device 18. In an operating state, the coil 14 feeds energy to the positioned item of cookware. The control unit 22 controls an energy supply to the coil 14 in an operating state. In an installation position, the coil 14 is arranged below the household appliance plate 18.

The household appliance device 10 has at least one coil support 24 (cf. FIG. 2). The household appliance device 10 has precisely one coil support 24 per coil 14. The coil 14 is arranged on the coil support 24 in an installation position.

In the present exemplary embodiment, the household appliance device 10, in particular for each coil 14, has five ferrite elements 12 (cf. FIG. 2). Only one of the objects present repeatedly in the figures is provided with a reference character in each case. Alternatively, the household appliance device 10, in particular for each coil 14, could have a lower number of ferrite elements 12, such as, for instance, two, in particular three or advantageously four ferrite elements 12. The household appliance device 10 could alternatively, in particular for each coil 14, have a larger number of ferrite elements 12, such as, for instance, at least six, in particular at least eight and advantageously at least ten ferrite elements 12. The ferrite elements 12 are embodied essentially identically, as a result of which only one ferrite element 12 of the ferrite elements 12 is described below.

In an assembled state, the ferrite element 12 is arranged, in particular fastened, on the coil support 24. The ferrite element 12 is provided for concentrating a magnetic flux supplied by a coil 14. In an installation position, the ferrite element 12 is arranged below the coil 14.

The ferrite element 12 has a proportion of MnO. In the present exemplary embodiment, the ferrite element 12 has a proportion of essentially 19.93% of MnO. Aside from the proportion of MnO, the ferrite element 12 has a proportion of NiO.

Ferrite elements 12 with different proportions of NiO are conceivable. In the table below, some examples of ferrite elements 12 with different proportions of NiO are listed. A ferrite element 12 referred to with “F01” is prior art and not inventive.

| | F01 | F01Ni08 | F01Ni16 | F01Ni24 | F01Ni32 | F01Ni40 | F01Ni48 |
|---|---|---|---|---|---|---|---|
| Fe₂O₃ [%] | 71.50 | 71.50 | 71.50 | 71.50 | 71.50 | 71.50 | 71.50 |
| MnO [%] | 22.45 | 21.82 | 21.19 | 20.56 | 19.93 | 19.30 | 18.67 |
| ZnO [%] | 6.05 | 5.88 | 5.71 | 5.54 | 5.37 | 5.20 | 5.03 |
| NiO [%] | 0.00 | 0.80 | 1.60 | 2.40 | 3.20 | 4.00 | 4.80 |
| Total [%] | 100.00 | 100.00 | 100.00 | 100.00 | 100.00 | 100.00 | 100.00 |
| Mn/Zn | 3.71 | 3.71 | 3.71 | 3.71 | 3.71 | 3.71 | 3.71 |
| Fe/Mn | 3.18 | 3.28 | 3.37 | 3.48 | 3.59 | 3.71 | 3.83 |
| Curie | 250 | 260 | 270 | 280 | 290 | 300 | 310 |
| temperature [° C.] | | | | | | | |
| Saturation flux | 242 | 256 | 279 | 292 | 306 | 318 | 329 |
| density [mT] | | | | | | | |
| Power loss | 87 | 74 | 64 | 61 | 65 | 76 | 91 |
| [mW/cm³] | | | | | | | |
| Position of power | 80 | 100 | 140 | 160 | 180 | 190 | 210 |
| loss [° C.] | | | | | | | |
| Initial | 3919 | 4090 | 3904 | 3968 | 3834 | 3512 | 3234 |
| permeability | | | | | | | |

In test series, which have been carried out with the different ferrite elements 12 listed in the table, a ferrite element 12 referred to with “FO1Ni32” has proven to be particularly preferred. This ferrite element 12 referred to with “FO1Ni32” is described below.

In the present exemplary embodiment the ferrite element 12 has a proportion, namely in particular a mass proportion and/or volume proportion of essentially 3.2% of NiO. Aside from the proportion of MnO and the proportion of NiO, the ferrite element 12 has a proportion of ZnO. In the present exemplary embodiment, the ferrite element 12 has a proportion of essentially 5.37% of ZnO.

The ferrite element 12 has, in particular aside from the proportion of MnO, the proportion of ZnO and the proportion of NiO, a proportion of Fe₂O₃. In the present exemplary embodiment, the ferrite element 12 has a proportion of essentially 71.50% of Fe₂O₃.

The ferrite element 12 has a Curie temperature of essentially 290° C. In the present exemplary embodiment, the ferrite element 12 has a saturation flux density of essentially 306 mT, namely in particular with a frequency of essentially 10 KHz and with a magnetic field strength of essentially 1200 A/m and with a temperature of essentially 200° C.

The ferrite element 12 is provided to bring about power losses of essentially 65 mW/cm³, namely in particular with a frequency of essentially 20 KHz, and with a magnetic flux of essentially 200 mT and with a temperature of essentially 200° C. The ferrite element 12 is provided to effect maximum power losses with a temperature of essentially 180° C.

In the present exemplary embodiment, the ferrite element 12 has an initial permeability of essentially 3834. In a method for producing the ferrite element 12 for the household appliance device 10, a ratio of Mn to Zn with a varying proportion of NiO is kept essentially constant.

### REFERENCE CHARACTERS

10 household appliance device
12 ferrite element
14 coil
16 household appliance
18 household appliance plate
20 user interface
22 control unit
24 coil support

1-10. (canceled)

11. A household appliance device, comprising:
a coil generating a magnetic flux; and
a ferrite element configured to concentrate the magnetic flux supplied by the coil, said ferrite element having a proportion of MnO and a proportion of NiO.

12. The household appliance device of claim 11, constructed in the form of a hob device.

13. The household appliance device of claim 11, wherein the coil is embodied as an induction heating element.

14. The household appliance device of claim 11, wherein the ferrite element has a mass proportion and/or volume proportion of at least 0.5% of NiO.

15. The household appliance device of claim 11, wherein the ferrite element has a mass proportion and/or volume proportion of at least 10% of NiO.

16. The household appliance device of claim 11, wherein the ferrite element has a proportion of ZnO.

17. The household appliance device of claim 11, wherein the ferrite element has a proportion of Fe₂O₃.

18. The household appliance device of claim 11, wherein the ferrite element has a Curie temperature of at least 250° C.

19. The household appliance device of claim 11, wherein the ferrite element has an initial permeability of at least 3000.

20. A household appliance, comprising a household appliance device, said household appliance device comprising a coil generating a magnetic flux, and a ferrite element configured to concentrate the magnetic flux supplied by the coil, said ferrite element having a proportion of MnO and a proportion of NiO.

21. The household appliance of claim 20, constructed in the form of a hob.

22. The household appliance of claim 20, wherein the coil is embodied as an induction heating element.

23. The household appliance of claim 20, wherein the ferrite element has a mass proportion and/or volume proportion of at least 0.5% of NiO.

24. The household appliance of claim 20, wherein the ferrite element has a mass proportion and/or volume proportion of at least 10% of NiO.

25. The household appliance of claim 20, wherein the ferrite element has a proportion of ZnO.

26. The household appliance of claim 20, wherein the ferrite element has a proportion of Fe₂O₃.

27. The household appliance of claim 20, wherein the ferrite element has a Curie temperature of at least 250° C.

28. The household appliance of claim 20, wherein the ferrite element has an initial permeability of at least 3000.

29. A method for producing a household appliance device, said method comprising:
concentrating by a ferrite element a magnetic flux supplied by a coil; and
forming the ferrite element with a proportion of MnO, a proportion of ZnO and a proportion of NiO, with a ratio of Mn to Zn having a varying proportion of NiO being kept at least essentially constant.
